(19) United States
(12) Patent Application Publication
(10) Pub. No.: US 2006/0125966 A1
(43) Pub. Date: Jun. 15, 2006

(54) Luminance and color separation

(75) Inventors: Gerard De Haan, Eindhoven (NL); Claus Nico Cordes, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/560,718

(22) PCT Filed: Jun. 16, 2004
(86) PCT No.: PCT/IB04/50922

§ 371 Date: Dec. 15, 2005

(30) Foreign Application Priority Data
Jun. 20, 2003 (EP) 03101831.0

(51) Int. Cl. H04N 9/77

(52) U.S. Cl. 348/663

(57) ABSTRACT

A luminance and color separation filter unit (300, 400, 500, 600, 700) for extracting a luminance signal (Y) and two color signals (U, V) from a composite color television signal (CVBS), comprising a chrominance (C) signal being modulated on a subcarrier which is located in the high-frequency part of the frequency spectrum of the luminance signal (Y), is disclosed. The filter unit (300, 400, 500, 600, 700) is arranged to compute at least one value of a set of values comprising an output luminance value (Y(x, n)) of a particular output pixel (x), a first color value (U(x, n)) of the particular output pixel (x) and a second color value (V(x, n)) of the particular output pixel (x) on basis of a first (F₁), a second (F₂) and a third (F₃) sample derived from the composite color television signal (CVBS), where the first (F₁), the second (F₂) and the third (F₃) sample have mutually different sub-carrier phases.

The invention relates to a luminance and color separation filter unit for extracting a luminance signal and two color signals from a composite color television signal, comprising a chrominance signal being modulated on a sub-carrier which is located in the high-frequency part of the frequency spectrum of the luminance signal.

The invention further relates to an image processing apparatus comprising:

receiving means for receiving a composite color television signal, comprising a chrominance signal being modulated on a sub-carrier which is located in the high-frequency part of the frequency spectrum of a luminance signal; and

a luminance and color separation filter unit for extracting the luminance signal and two color signals from the composite color television signal.

The invention further relates to a method of extracting a luminance signal and two color signals from a composite color television signal, comprising a chrominance signal being modulated on a sub-carrier which is located in the high-frequency part of the frequency spectrum of the luminance signal.

The invention further relates to a computer program product to be loaded by a computer arrangement, comprising instructions to extract a luminance signal and two color signals from a composite color television signal, comprising a chrominance signal being modulated on a sub-carrier which is located in the high-frequency part of the frequency spectrum of the luminance signal, the computer arrangement comprising processing means and a memory.

With HDTV sets becoming readily available in many markets, digital television is rapidly gaining popularity. However, analog television is expected to remain the most important television standard for the foreseeable future. With the advent of increasingly larger televisions that exhibit significantly higher resolutions, a continued quality improvement of the decoded analog television signal is desirable.

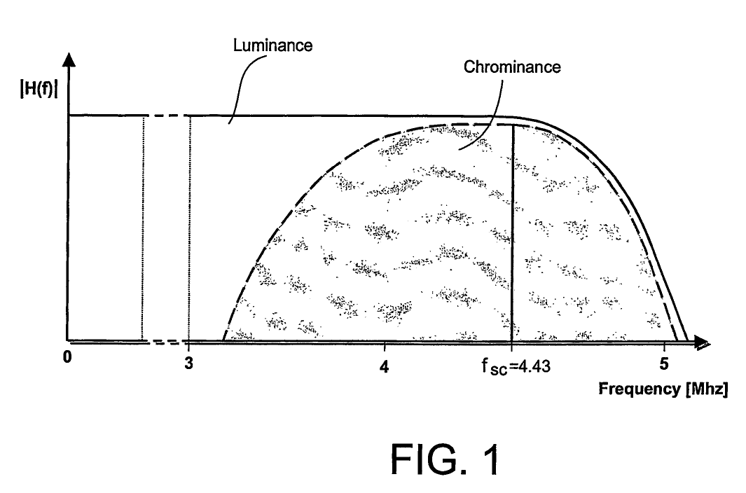

Many artifacts that continue to exist in analog television are caused by the imperfect separation of luminance and chrominance in composite color video signals. This separation is required due to the fact that the chrominance component (C) is transmitted by modulating it onto a sub-carrier in the high-frequency part of the luminance, i.e. gray-value (Y) spectrum, as illustrated in FIG. 1. As both components share the same frequency space, their separation at the receiver side can only be imperfect and often results in artifacts known as cross-color and cross-luminance.

A first type of low-cost PAL and NTSC decoders use horizontal band-pass/notch filters for Y/C separation. See pages 428-433 in “Video demystified: a handbook for the digital engineer 3rd edition”, by K. Jack. Eagle Rock: LLH Technical Publishing, 2001. ISBN 1-878707-56-6. Here, the notch filter in the luminance path suppresses most of the chrominance, but attenuates the high-frequency luminance as well. Similarly, the band-pass filter in the chrominance path passes the chrominance, but also passes the high-frequency luminance. Hence, these decoders suffer from a loss of horizontal luminance resolution and strong cross-luminance and cross-color artifacts.

A second type, more advanced decoders aim at an improved Y/C separation by using so called comb-filters. See e.g. the article “Three-dimensional pre- and post-filtering for PAL TV signals”, by D. Teichner, in IEEE Transactions in Consumer Electronics, Vol. (1988), No. 1, pp. 205-227. This type of decoders exploit the opposite subcarrier phase of certain vertically or temporally adjacent samples to separate the luminance from the chrominance. The basic principle can be explained by taking a composite PAL sample, F₁ that is encoded at an arbitrary phase φ:
F₁=Y+U sin(φ)+V cos(φ) (1)
and a second sample F₂ encoded at 180°+φ, of which it is assumed that it was encoded from identical luminance and chrominance values:
F₂=Y+U sin(φ+180°)+V cos(φ+180°)
F₂=Y−U sin(φ)−V cos(φ) (2)
Now, the addition of F₁ and F₂ and subsequent division by two results in the separated luminance Y, whereas the subtraction and subsequent division by two yields the modulated chrominance U sin(φ)+V cos(φ). This means that perfect Y/C separation is possible if F₁ and F₂ were indeed encoded from highly correlated YUV values.

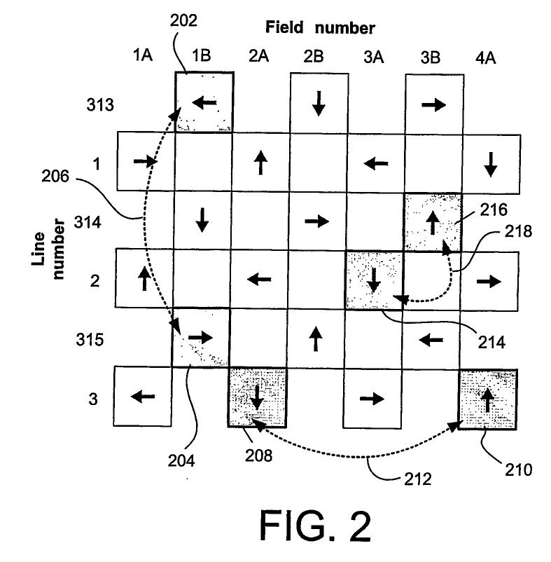

Current state-of-the-art comb-filters adaptively combine various spatial and temporal comb-filters by filtering along the direction of the highest detected correlation. See pages 115-118 in “Video-Signalverarbeitung”, by C. Hentschel. Stuttgart: Teubner, 1998. ISBN 3-519-06250-X. (See also FIG. 2). However, particularly in vertically detailed and/or moving areas, the available comb-filtering directions are often too limited due to the required opposite sub-carrier phase. As such, even modern 3D comb-filters suffer from cross-talk artifacts and loss of resolution.

It is an object of the invention to provide a filter unit of the kind described in the opening paragraph with an improved luminance and color separation.

This object of the invention is achieved in that the filter unit is arranged to compute at least one value of a set of values comprising an output luminance value of a particular output pixel, a first color value of the particular output pixel and a second color value of the particular output pixel on basis of a first, a second and a third sample derived from the composite color television signal, where the first, the second and the third sample have mutually different sub-carrier phases. To increase the likelihood of being able to select highly correlated samples for Y/C separation, the possible set of samples is expanded compared with prior art filters. This expansion is achieved by also taking into account the samples with a non-opposite sub-carrier phase relationship with respect to the current sample.

By including these samples in the set of candidates the decoding quality, i.e. luminance and color separation quality is increased.

The working of the filter unit according to the invention is based on the fact that a received input sample F₁ introduces three unknown variables, namely the luminance value Y, the first color value U and the second color value V, and one known value, i.e. the locally regenerated sub-carrier phase α. Basic algebra shows that, given three linear equations, these three unknown variables can be solved. Hence, at least three input samples are required to compute the three unknown variables.

An embodiment of the filter unit according to the invention comprises a sample acquisition unit to acquire the first, the second and the third sample from three portions of the composite color television signal, the three portions corresponding to three successive images, the sample acquisition unit being controlled by a motion estimator for computing motion vectors, representing motion between parts of the three successive images. An advantage of this embodiment according to the invention is that three samples which are positioned along a locally estimated motion trajectory can be selected. Hence, even in the case of motion, a relatively good luminance and color separation is achieved. The motion estimation might be performed on basis of the composite color television signal. Preferably, an initial luminance and color separation is performed, e.g. by means of a horizontal band-pass/notch filter. Subsequently, the output of the initial luminance and color separation is applied for the motion estimation.

Another embodiment of the filter unit according to the invention comprises a sample acquisition unit to acquire the first, the second and the third sample from three portions of the composite color television signal, the three portions corresponding to a single image, the sample acquisition unit being controlled by means for estimating an edge orientation in the single image. An advantage of this embodiment according to the invention is that three samples which are positioned along a locally estimated edge can be selected. The probability that these three samples are correlated is relatively high. Also edges which are diagonal, i.e. any arbitrary angle, relative to the pixel matrix of the image are detected and useful for the filter unit according to the invention. In prior art filter units, the relative positions of the applied samples is strict. In other words, the selection of samples in prior art filters is restricted.

An embodiment of the filter unit according to the invention comprises:

a first low pass filter for filtering a first one of the two color signals;

a second low pass filter for filtering a second one of the two color signals;

a modulator connected to the first low pass filter and the second low pass filter, for re-modulating the filtered first one of the two color signals and the filtered second one of the two color signals; and

a subtraction unit for subtracting the output of the modulator from the composite color television signal.

Preferably the first and second low pass filter have a characteristic which matches the low-pass filters being applied in PAL or NTSC encoders, e.g. 1.3 MHz and the modulator is arranged to modulate with a sub-carrier being applied in the PAL or NTSC encoders. An advantage of this embodiment according to the invention is that a further improved Y/C separation is achieved.

An embodiment of the filter unit according to the invention comprises a spatial up-conversion unit for computing the first, the second and the third sample on basis of interpolation of samples extracted from the composite color television signal. By means of the spatial up-conversion unit the set of samples is further increased, resulting in even higher probabilities of being able to select triples of samples which are relatively well correlated.

It is a further object of the invention to provide an image processing apparatus of the kind described in the opening paragraph with an improved luminance and color separation.

This object of the invention is achieved in that the filter unit is arranged to compute at least one value of a set of values comprising an output luminance value of a particular output pixel, a first color value of the particular output pixel and a second color value of the particular output pixel on basis of a first, a second and a third sample derived from the composite color television signal, where the first, the second and the third sample have mutually different sub-carrier phases. Optionally, the image processing apparatus comprises a display device for displaying images being represented by the luminance signal and the two color signals. The image processing apparatus might be a TV.

It is a further object of the invention to provide a method of the kind described in the opening paragraph resulting in an improved luminance and color separation.

This object of the invention is achieved in computing at least one value of a set of values comprising an output luminance value of a particular output pixel, a first color value of the particular output pixel and a second color value of the particular output pixel on basis of a first, a second and a third sample derived from the composite color television signal, where the first, the second and the third sample have mutually different sub-carrier phases.

It is a further object of the invention to provide a computer program product of the kind described in the opening paragraph resulting in an improved luminance and color separation.

This object of the invention is achieved in that, the computer program product, after being loaded, provides said processing means with the capability to carry out: computing at least one value of a set of values comprising an output luminance value of a particular output pixel, a first color value of the particular output pixel and a second color value of the particular output pixel on basis of a first, a second and a third sample derived from the composite color television signal, where the first, the second and the third sample have mutually different sub-carrier phases.

Modifications of the filter unit and variations thereof may correspond to modifications and variations thereof of the method described.

These and other aspects of the filter unit, of the image processing apparatus, of the method and of the computer program product according to the invention will become apparent from and will be elucidated with respect to the implementations and embodiments described hereinafter and with reference to the accompanying drawings, wherein:

FIG. 1 schematically shows a spectrum of a composite PAL video signal;

FIG. 2 schematically show sub-carrier phases of samples in adjacent video lines for successive fields;

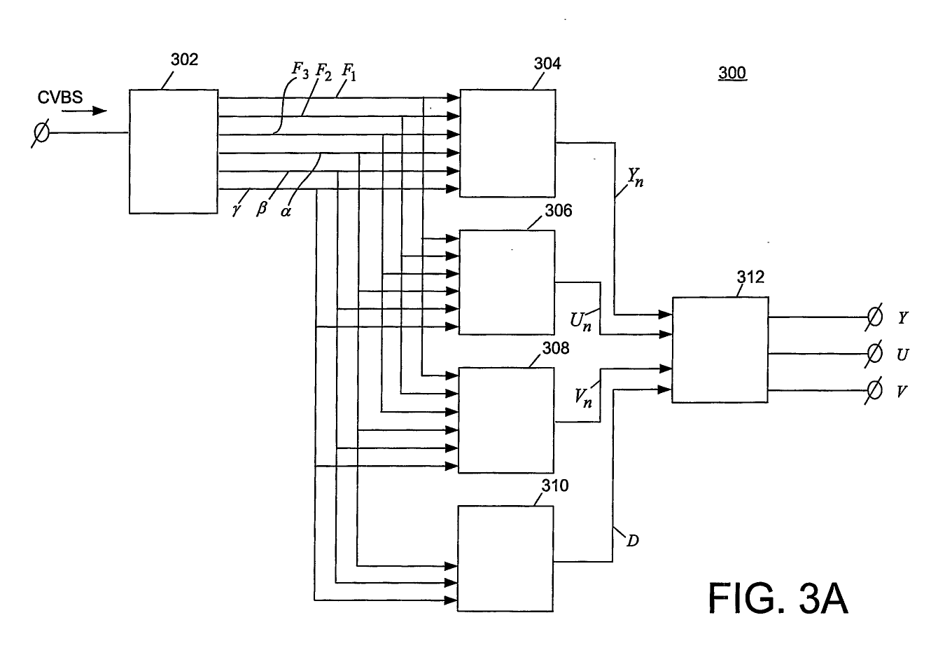

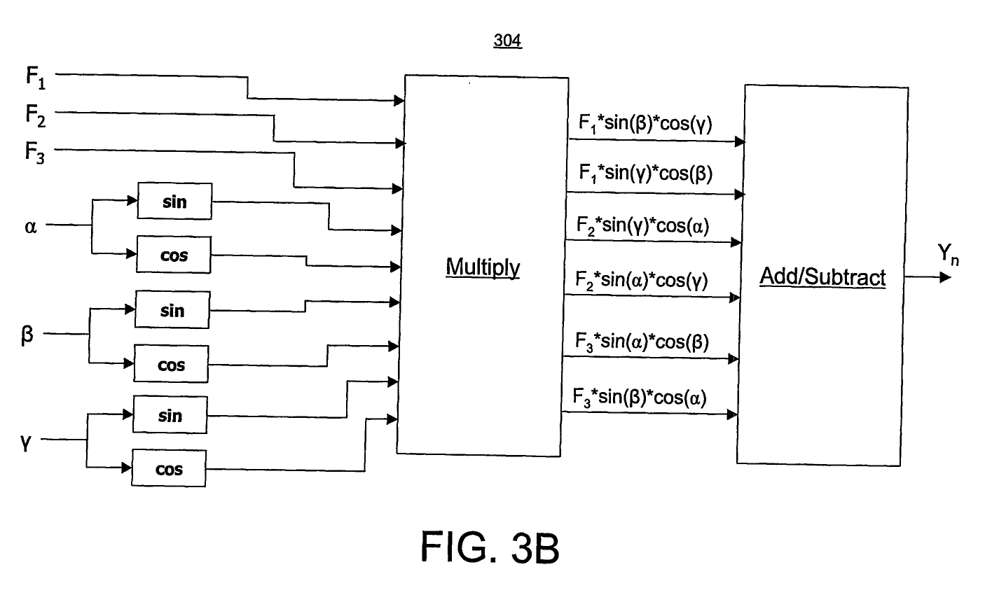

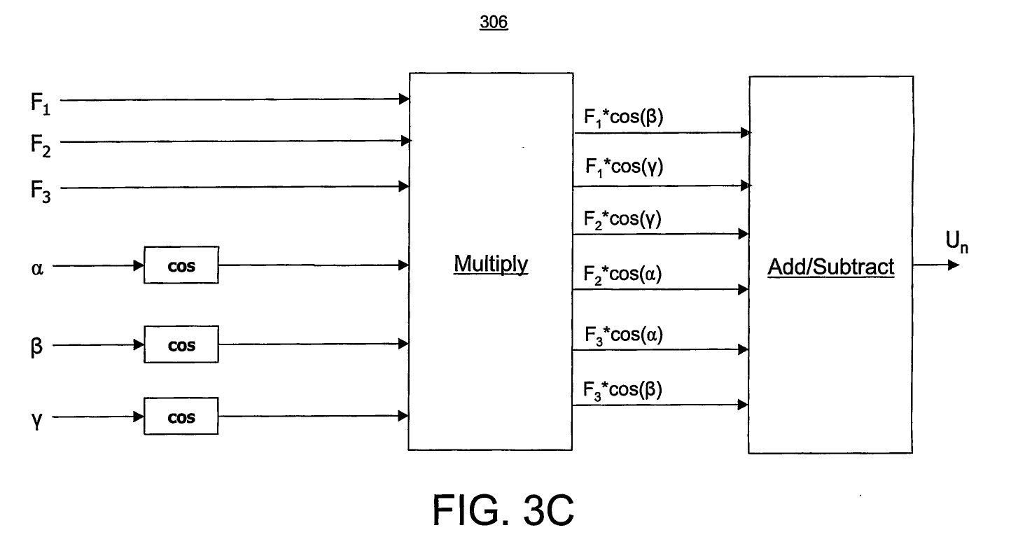

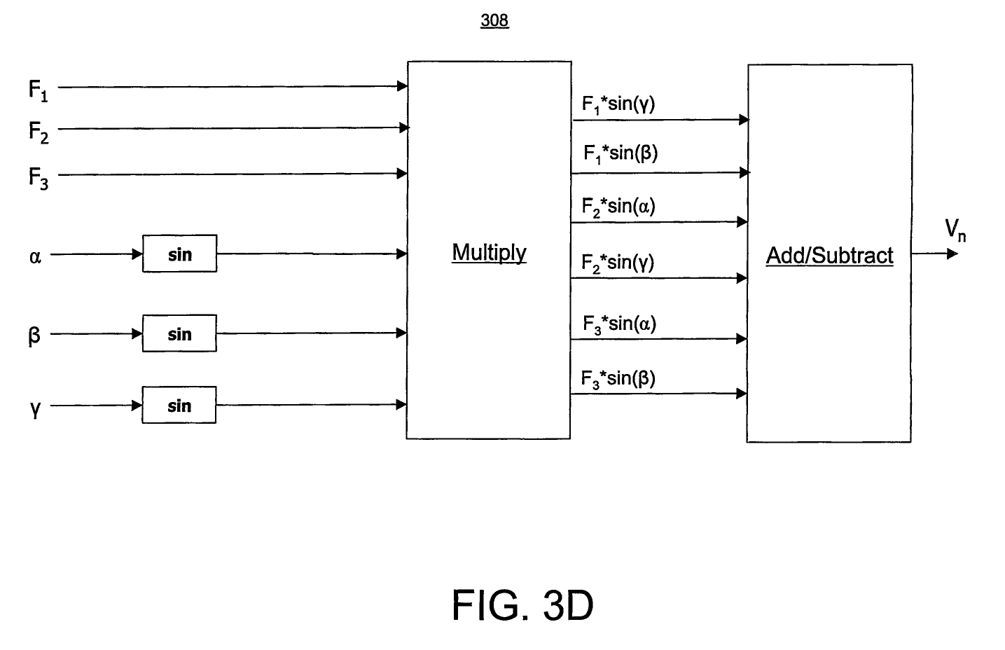

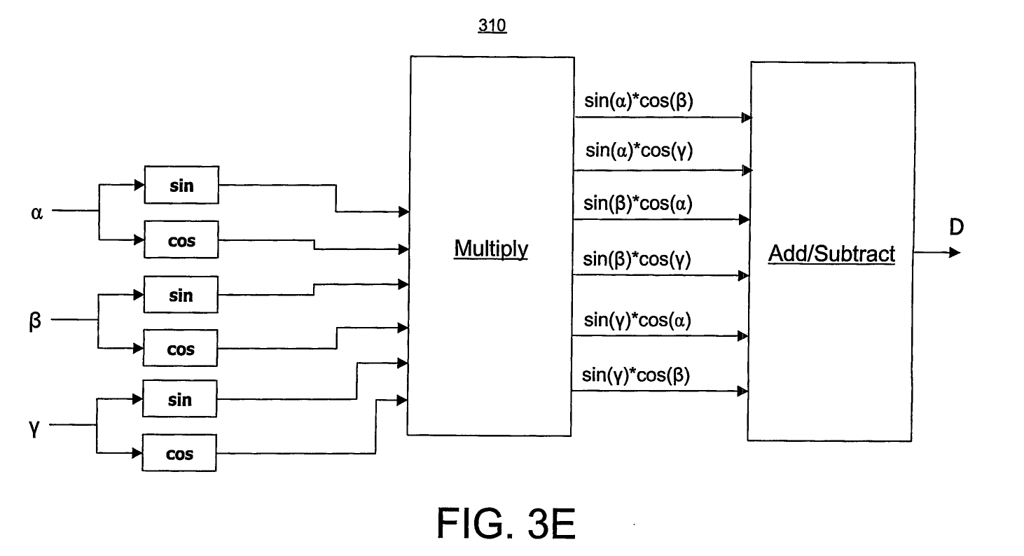

FIG. 3A schematically shows a filter unit according to the invention;

FIG. 3B schematically shows a detail of the luminance path of the filter unit of FIG. 3A;

FIG. 3C schematically shows a detail of the first color path of the filter unit of FIG. 3A;

FIG. 3D schematically shows a detail of the second color path of the filter unit of FIG. 3A;

FIG. 3E schematically shows a detail of the normalize path of the filter unit of FIG. 3A;

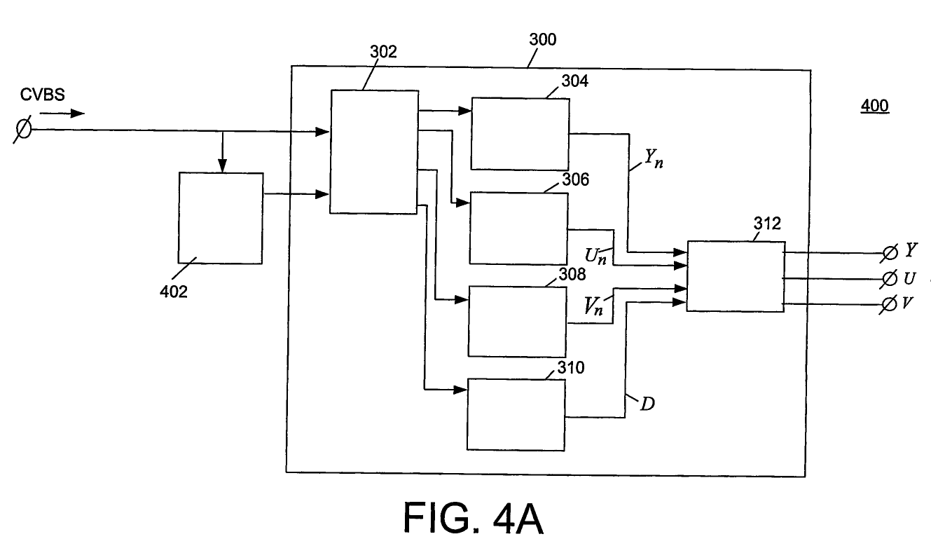

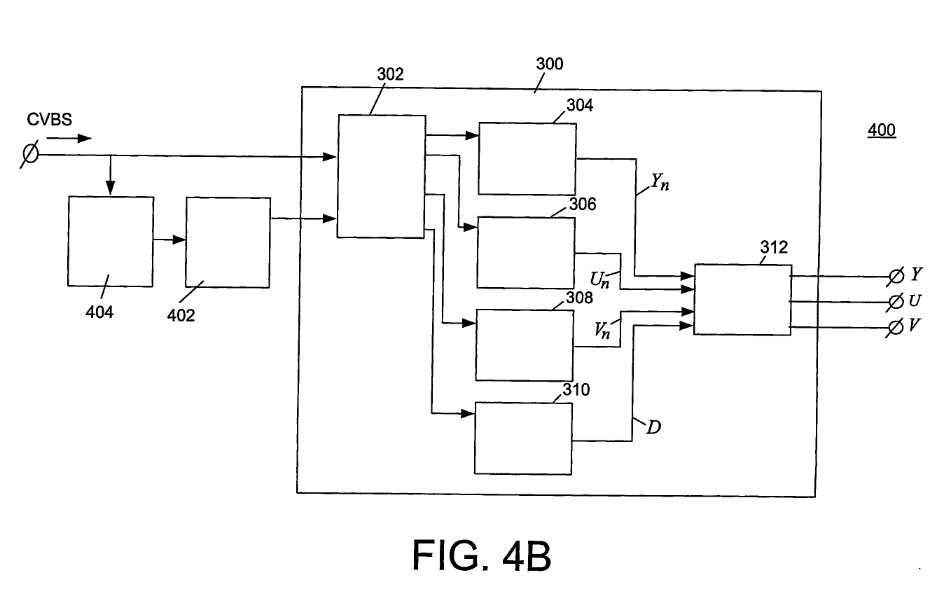

FIGS. 4A and 4B schematically show a filter unit according to the invention comprising a sample acquisition unit being controlled by a motion estimator;

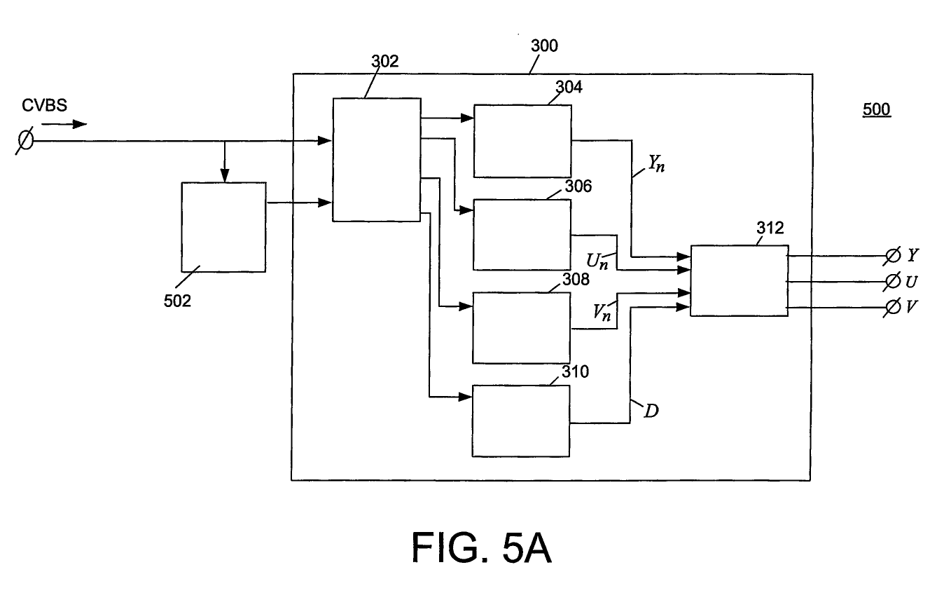

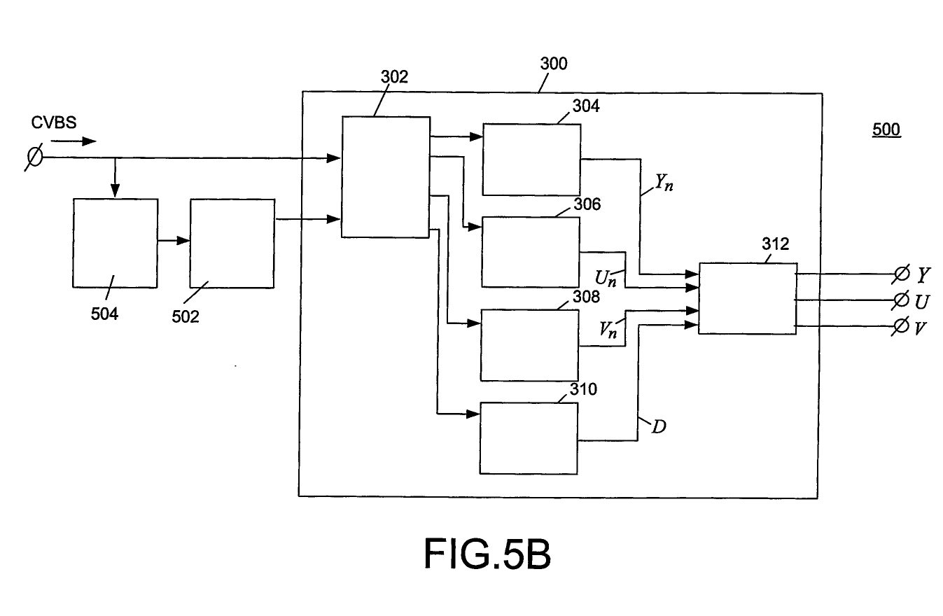

FIGS. 5A and 5B schematically show a filter unit according to the invention comprising a sample acquisition unit being controlled by an edge detection unit;

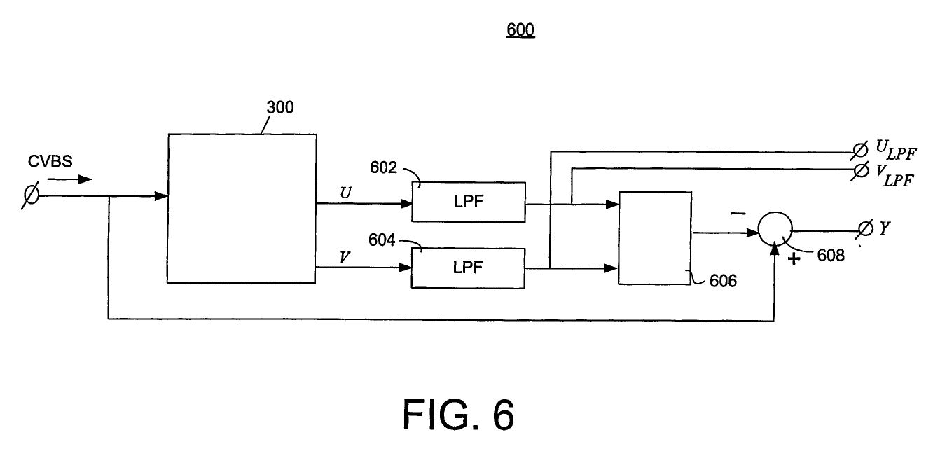

FIG. 6 schematically shows a filter unit according to the invention comprising a re-modulation unit;

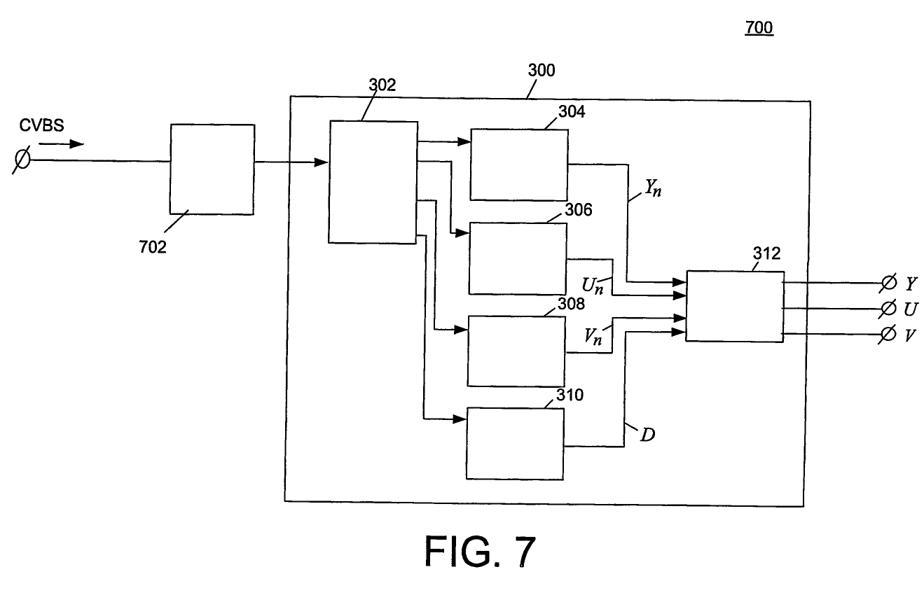

FIG. 7 schematically shows a filter unit according to the invention and an up-conversion unit; and

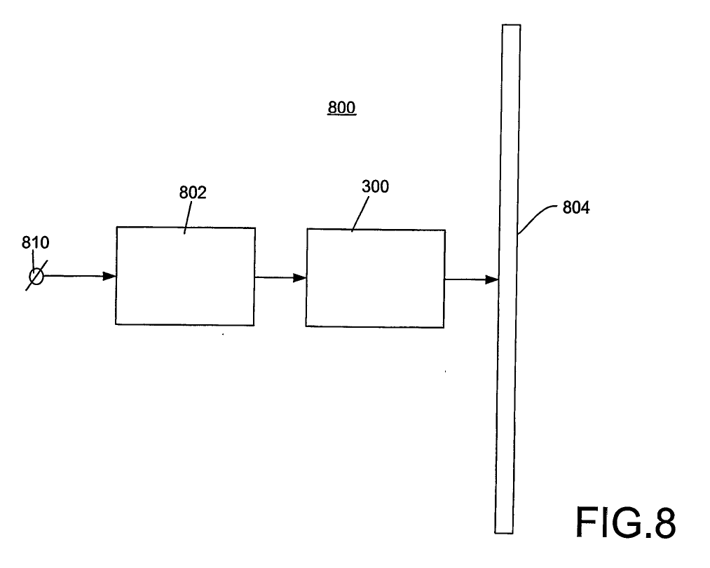

FIG. 8 schematically shows an image processing apparatus according to the invention.

Same reference numerals are used to denote similar parts throughout the figures.

FIG. 1 schematically shows a spectrum of a composite PAL video signal. In order to comprehend the problems involved in Y/C separation, one has to understand the standards for the transmission of analog color television signals, such as the PAL, NTSC and SECAM standards described in ITU-R BT.470. For these standards, the requirement of backward compatibility to existing black-and-white televisions dictates that the transmission of chrominance (C) has to take place within the band available for the gray-scales (Y).

For PAL, the chrominance components U and V are amplitude modulated in quadrature onto a sub-carrier frequency of 4.43 MHz. The resulting one-dimensional spectrum of the composite PAL video signal is illustrated in FIG. 1. In addition, the sign of the V-component, the so-called V-switch, is inverted every other line to reduce the influence of phase errors. More formally, the above is described in Equation 3, where \vec{x} indicates the pixel position in a given field n, F_{sc} the sub-carrier frequency and F the resulting composite PAL signal.
F(\vec{x},n)=Y(\vec{x},n)+U(\vec{x},n)sin(2πF_{sc}t)±V(\vec{x},n)cos(2πF_{sc}t) (3)

For NTSC, the somewhat differently defined chrominance components I and Q are amplitude modulated in quadrature onto a sub-carrier frequency of 3.58 MHz. As no alternating sign is applied to either chrominance component, there is an increased sensitivity to phase errors that can result in an erroneous hue of the decoded picture. The one-dimensional spectrum is similar to that of PAL, except that now the available video bandwidth is limited to approximately 4.2 MHz. Equation 4 formally defines NTSC encoding:
F(\vec{x},n)=Y(\vec{x},n)+I(\vec{x},n)sin(2πF_{sc}t)+Q(\vec{x},n)cos(2πF_{sc}t) (4)

The remainder of this specification discusses the Y/C separation of PAL composite color video signals. However, the Y/C separation of NTSC signals is nearly identical to the described separation of PAL signals with equal V-switches. First a short description of prior art Y/C separation filters is provided.

At the television receiver, the required separation of Y and C can only be imperfect as both components share the same frequency space. The early decoders for PAL and NTSC composite video signals used two simple one-dimensional horizontal filters to separate luminance and chrominance from the composite signal. These filters are so-called notch and band-pass filters.

In the luminance path, a notch filter suppresses frequencies near the sub-carrier frequency to eliminate horizontal chrominance components. Due to the small stop band of the notch filter, high-frequency chrominance components, as they occur on horizontal colored transitions, will be insufficiently attenuated. This introduces cross-talk from chrominance to luminance, resulting in the so-called cross-luminance artifacts. Furthermore, the luminance resolution is significantly reduced, as the notch filter suppresses any luminance components in the stop-band.

In the chrominance path, a band-pass filter separates the high frequency components from the composite signal. Although the pass-band of the band-pass filter contains mostly chrominance information, high-frequency luminance is present as well. Again, cross-talk will occur as the high-frequency luminance will be decoded as chrominance, resulting in the so-called cross-color artifacts.

The band-pass and notch filters can achieve perfect Y/C separation if the luminance and chrominance values of horizontally adjacent samples are identical, as here the frequency spectrum consists of a DC luminance component and a chrominance component at the sub-carrier frequency. However, if the correlation along the horizontal axis is insufficient, the frequency spectrum contains high-frequency luminance and/or chrominance components. The horizontal separation is now imperfect and results in cross-talk artifacts in the decoded signal.

In areas where horizontally adjacent samples are insufficiently correlated, additional methods for Y/C separation are desirable. For that purpose, so-called comb-filters can be used to separate luminance and chrominance along the vertical or temporal axis. Their underlying principles are similar to those of the standard decoder, i.e. passing the desired frequency components and suppressing the undesired frequency components.

However, the luminance and chrominance are now modulated with harmonics of fₕ, i.e. the line frequency, and fᵥ, i.e. the picture frequency. Along with the chosen sub-carrier frequencies of PAL and NTSC, this results in interleaved and non-overlapping luminance and chrominance frequency components in the direction where sufficient correlation is present. For example, in non-moving areas of the picture, the samples are highly correlated along the temporal axis, and as such, the luminance and chrominance components are interleaved and non-overlapping along that axis. A filter with a comb-shaped amplitude response in that particular direction can therefore be used to separate the luminance and chrominance.

A typical comb-filter implementation uses two samples with an opposite relative phases, i.e. having a phase difference of 180° to separate luminance and chrominance. See Equations 1 and 2.

However, perfect separation is only possible if both composite samples were encoded from identical Y, U and V values. Only in this case, the positions of the luminance and chrominance frequency components correspond to those of the comb-filter. Therefore, sufficient correlation is required along the comb-filtering direction in order to prevent decoding errors. This is analogous to the horizontal band-pass/notch filters, where sufficient correlation is required along the horizontal axis.

An inherent drawback of the standard comb-filter is the low density of samples that both meet the required phase relationship, and are spatially and/or temporally adjacent. Due to this limited set of samples, situations will occur where neither of the neighboring samples exhibit sufficient correlation with respect to the current sample, thereby causing artifacts in the decoded video.

FIG. 2 schematically show sub-carrier phases of samples 202, 204, 208, 210, 214 and 216 in adjacent video lines 313, 1, 314, 2, 315 and 3 for successive fields 1A, 1B, 2A, 2B, 3A, 3B and 4A. Here, the arrow equals the sub-carrier phase, e.g. pointing up denotes 0° and to the right denotes 90°. Besides that, pairs of samples 206, 212 and 218 are depicted which are used for standard comb-filters:

the pair 206 of samples 202 and 204 correspond to a line comb-filter;

the pair 212 of samples 208 and 210 correspond to a frame comb-filter; and

the pair 218 of samples 214 and 216 correspond to a field comb-filter.

FIG. 3A schematically shows a filter unit 300 according to the invention. In particular FIG. 3A schematically shows a PAL decoder. The filter unit 300 is provided with a composite color television signal CVBS, comprising a chrominance signal being modulated on a sub-carrier which is located in the high-frequency part of the frequency spectrum of the luminance signal. The output of the filter unit 300 comprises a luminance signal Y, a first color signal U and a second color signal V. The filter unit 300 comprises:

a sample acquisition unit 302 which is arranged to acquire a first F₁, a second F₂ and a third F₃ sample from the received composite color television signal CVBS and to regenerate three signals α, β and γ corresponding to the sub-carrier used for encoding of the video data;

a first processing unit 304 for computing a first intermediate signal Yₙ. FIG. 3B schematically shows a detail of the first processing unit 304;

a second processing unit 306 for computing a second intermediate signal Uₙ. FIG. 3C schematically shows a detail of the second processing unit 306;

a third processing unit 308 for computing a third intermediate signal Vₙ. FIG. 3D schematically shows a detail of the second processing unit 308;

a fourth processing unit 310 for computing a fourth intermediate signal D. FIG. 3E schematically shows a detail of the fourth processing unit 310; and

a division unit 312 for computing the luminance signal Y, the first color signal U and the second color signal V on basis of the intermediate signals Yₙ, Uₙ, Vₙ and D.

The sample acquisition unit 302, the processing units 304-310 and the division unit 312 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality. It should be noted that the co-sinus and sinus computation units in the different processing units 304-310 can be shared.

The filter unit 300 is arranged to compute an output luminance value of a particular output pixel, a first color value of the particular output pixel and a second color value of the particular output pixel on basis a first F₁, a second F₂ and a third F₃ sample derived from the composite color television signal CVBS, where the first, the second and the third sample have mutually different sub-carrier phases.

A received composite sample, F(\vec{x}, n) introduces three unknown variables, namely the values of Y, U and V, and one known value, i.e. the locally regenerated sub-carrier phase ωt. Basic algebra shows that, given three linear equations, these three unknown variables can be solved. This means that three composite samples, encoded from Y, U and V values, can be used to separate the Y, U and V components exactly. However, in the situation that the composite samples were encoded from non-identical Y, U and V values, perfect separation is not possible and errors in the decoded values will occur.

To discuss the decoding of samples with non-opposite phases in more detail, two situation with respect to the V-switch of three composite samples should be considered:

The V-switch of all three samples is identical; or

One of the three samples has an unequal V-switch with respect to the other samples.

Therefore a distinction between the decoding of samples with identical V-switches, and the decoding of samples with non-identical V-switches is made. Although the following calculations are applicable to PAL signals, identical principles apply to NTSC as to PAL signals with identical V-switches. Then, the chrominance components I and Q are used instead of U and V.

In the case of identical V-switches, consider three composite samples encoded from the same Y, U and V values as shown in Equation 5. In order to obtain three independent equations, the phases were chosen to be unequal, i.e. α≈β≈γ. Also, the V-switch of all V components is chosen to be positive. In the case of all negative V-switches, the situation is identical expect for an inversion of the sign of the decoded V component.
F₁=Y+U·sin(α)+V·cos(α)
F₂=Y+U·sin(β)+V·cos(β)
F₃=Y+U·sin(γ)+V·cos(γ) (5)
By solving these three linear equations for the Y, U and V components, the expressions in Equations 6 and 7 are obtained. Here, the Y, U and V components are expressed in terms of the three original composite samples and their corresponding sub-carrier phase.

$$\begin{matrix}{Y}_{n} = \begin{matrix}+ {F}_{1} \cdot sin ( β ) \cdot cos ( γ ) - {F}_{1} \cdot sin ( γ ) \cdot cos ( β ) \\ + {F}_{2} \cdot sin ( γ ) \cdot cos ( α ) - {F}_{2} \cdot sin ( α ) \cdot cos ( γ ) \\ + {F}_{3} \cdot sin ( α ) \cdot cos ( β ) - {F}_{3} \cdot sin ( β ) \cdot cos ( α )\end{matrix} \\ {U}_{n} = \begin{matrix}+ {F}_{1} \cdot cos ( β ) - {F}_{1} \cdot cos ( γ ) + {F}_{2} \cdot cos ( γ ) \\ - {F}_{2} \cdot cos ( α ) + {F}_{3} \cdot cos ( α ) - {F}_{3} \cdot cos ( β )\end{matrix} \\ {V}_{n} = \begin{matrix}+ {F}_{1} \cdot sin ( γ ) - {F}_{1} \cdot sin ( β ) + {F}_{2} \cdot sin ( α ) \\ - {F}_{2} \cdot sin ( γ ) + {F}_{3} \cdot sin ( β ) - {F}_{3} \cdot sin ( α )\end{matrix} \\ D = \begin{matrix}+ sin ( α ) \cdot cos ( β ) - sin ( α ) \cdot cos ( γ ) \\ + sin ( β ) \cdot cos ( γ ) - sin ( β ) \cdot cos ( α ) \\ + sin ( γ ) \cdot cos ( α ) - sin ( γ ) \cdot cos ( β )\end{matrix} \\ with \text{:} & ( 6 ) \\ Y = \frac{{Y}_{n}}{D} , U = \frac{{U}_{n}}{D} , V = \frac{{V}_{n}}{D} & ( 7 )\end{matrix}$$

A similar calculation can be performed for samples with non-identical V-switches. Two situations can be distinguished

The V-switch of one composite sample is positive, whereas the remaining samples have a negative V-switch; or

The V-switch of one composite sample is negative, whereas the remaining samples have a positive V-switch.

The first situation is shown in Equation 8, whereas the second situation will not be covered, as it is identical except for an inversion in sign of the decoded V component.
F₁=Y+U·sin(α)+V·cos(α)
F₂=Y+U·sin(β)+V·cos(β)
F₃=Y+U·sin(γ)+V·cos(γ) (8)
By solving these equations for the Y, U and V components, the expressions depicted in Equations 9 and 10 can be obtained.

$$\begin{matrix}{Y}_{n} = \begin{matrix}+ {F}_{1} \cdot sin ( β ) \cdot cos ( γ ) - {F}_{1} \cdot sin ( γ ) \cdot cos ( β ) \\ - {F}_{2} \cdot sin ( γ ) \cdot cos ( α ) - {F}_{2} \cdot sin ( α ) \cdot cos ( γ ) \\ + {F}_{3} \cdot sin ( α ) \cdot cos ( β ) + {F}_{3} \cdot sin ( β ) \cdot cos ( α )\end{matrix} \\ {U}_{n} = \begin{matrix}+ {F}_{1} \cdot cos ( β ) - {F}_{1} \cdot cos ( γ ) + {F}_{2} \cdot cos ( γ ) \\ + {F}_{2} \cdot cos ( α ) - {F}_{3} \cdot cos ( α ) - {F}_{3} \cdot cos ( β )\end{matrix} \\ {V}_{n} = \begin{matrix}+ {F}_{1} \cdot sin ( β ) - {F}_{1} \cdot sin ( γ ) + {F}_{2} \cdot sin ( γ ) \\ - {F}_{2} \cdot sin ( α ) + {F}_{3} \cdot sin ( α ) - {F}_{3} \cdot sin ( β )\end{matrix} \\ D = \begin{matrix}+ sin ( α ) \cdot cos ( β ) - sin ( α ) \cdot cos ( γ ) \\ + sin ( β ) \cdot cos ( γ ) + sin ( β ) \cdot cos ( α ) \\ - sin ( γ ) \cdot cos ( α ) - sin ( γ ) \cdot cos ( β )\end{matrix} \\ with \text{:} & ( 9 ) \\ Y = \frac{{Y}_{n}}{D} , U = \frac{{U}_{n}}{D} , V = \frac{{V}_{n}}{D} & ( 10 )\end{matrix}$$

FIGS. 4A and 4B schematically show a filter unit 400 according to the invention comprising a sample acquisition unit 302 being controlled by a motion estimator 402. The filter unit 400 comprises a sample acquisition unit 302 to acquire the first, the second and the third sample from three portions of the composite color television signal, the three portions corresponding to three successive images. The sample acquisition unit 302 is controlled by a motion estimator 402 for computing motion vectors, representing motion between parts of the three successive images. In FIG. 4A is depicted that the motion estimator 402 is provided with the composite color television signal CVBS. In FIG. 4B an alternative implementation is depicted. In the latter case the motion estimator 402 is provided with a luminance signal which is obtained by means of an initial Y/C separation being performed by the initial separation filter 404. This initial separation filter 404 might be based on any known type of Y/C separation filter as discussed above, e.g. a horizontal band-pass/notch filters or a comb-filter.

FIGS. 5A and 5B schematically show a filter unit 500 according to the invention comprising a sample acquisition unit 302 being controlled by an edge detection unit 502. The filter unit 500 comprises a sample acquisition unit 302 to acquire the first, the second and the third sample from three portions of the composite color television signal, the three portions corresponding to a single image. The sample acquisition unit is controlled by an edge detection unit 502 for detecting the orientation of edges in the single image. In FIG. 5A is depicted that the edge detection unit 502 is provided with the composite color television signal CVBS. In FIG. 5B an alternative implementation is depicted. In the latter case the edge detection unit 502 is provided with a luminance signal which is obtained by means of an initial Y/C separation being performed by the initial separation filter 504. This initial separation filter 504 might be based on any known type of Y/C separation filter as discussed above, e.g. a horizontal band-pass/notch filters or a comb-filter.

FIG. 6 schematically shows a filter unit 600 according to the invention comprising:

a first low pass filter 602 for filtering a first U one of the two color signals;

a second low pass filter 604 for filtering a second V one of the two color signals;

a modulator 606 connected to the first low pass filter 602 and the second low pass filter 604, for re-modulating the filtered first U_{LPF} one of the two color signals and the filtered second V_{LPF} one of the two color signals; and

a subtraction unit 608 for subtracting the output of the modulator 606 from the composite color television signal CVBS, resulting in a luminance signal Y. The first 602 and second low pass filter 604 have a characteristic which matches the low pass filters being applied in PAL encoders, i.e. 1.3 MHz and the modulator 606 is arranged to modulate with a sub-carrier being applied in PAL encoders. In this embodiment according to the invention the two filtered color signals U_{LPF} and V_{LPF} do not or hardly comprise frequency components which were not present in the original color signals before encoding. Furthermore, the luminance signal also better matches the original luminance signal before encoding by a video encoding unit, i.e. a PAL encoder.

FIG. 7 schematically shows a filter unit 700 according to the invention and an up-conversion unit 702 being arranged to compute the first, the second and the third sample on basis of interpolation of samples extracted from the composite color television signal. By means of the interpolation even more candidate samples, or decoding options are created which can be applied to compute the output color and luminance signals. In other word, the probability that there are samples with a relatively high correlation is further increased.

It should be noted that different features as explained in connection with FIGS. 4, 5, 6 and 7 can be combined. Optionally, the sample acquisition unit 302 is controlled by both an edge detection unit 502 and a motion estimator 402. Furthermore, a filter unit comprising such a sample acquisition unit 302 which is controlled by both an edge detection unit 502 and a motion estimator 402 might comprise an up-conversion unit 702 and/or the low-pass filters 602 and 604 in combination with the modulator 606 and the subtraction unit 608.

FIG. 8 schematically shows an image processing apparatus 800 according to the invention, comprising:

Receiving means 802 for receiving a signal representing input images.

The filter unit 300, 400, 500, 600, 700 as described in connection with any of the FIGS. 3A, 4, 5, 6 and 7; and

A display device 804 for displaying images being represented by the luminance signal and the two color signals.

The signal may be a broadcast signal received via an antenna or cable but may also be a signal from a storage device like a VCR (Video Cassette Recorder) or Digital Versatile Disk (DVD). The signal is provided at the input connector 810. The image processing apparatus 800 might e.g. be a TV. Alternatively the image processing apparatus 804 does not comprise the optional display device but provides the output images to an apparatus that does comprise a display device 804. Then the image processing apparatus 400 might be e.g. a VCR player. Optionally the image processing apparatus 800 comprises storage means, like a hard-disk or means for storage on removable media, e.g. optical disks.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A luminance and color separation filter unit (300, 400, 500, 600, 700) for extracting a luminance signal (Y) and two color signals (U, V) from a composite color television signal (CVBS), comprising a chrominance (C) signal being modulated on a sub-carrier which is located in the high-frequency part of the frequency spectrum of the luminance signal (Y), characterized in that the filter unit (300, 400, 500, 600, 700) is arranged to compute at least one value of a set of values comprising an output luminance value (Y(\vec{x},n)) of a particular output pixel (\vec{x}), a first color value (U(\vec{x}, n)) of the particular output pixel (\vec{x}) and a second color value (V(\vec{x},n)) of the particular output pixel (\vec{x}) on basis of a first (F₁), a second (F₂) and a third (F₃) sample derived from the composite color television signal (CVBS), where the first (F₁), the second (F₂) and the third (F₃) sample have mutually different sub-carrier phases.

2. A luminance and color separation filter unit (400) as claimed in claim 1, characterized in that the filter unit (400) comprises a sample acquisition unit (302) to acquire the first (F₁), the second (F₂) and the third (F₃) sample from three portions of the composite color television signal, the three portions corresponding to three successive images, the sample acquisition unit (302) being controlled by a motion estimator (402) for computing motion vectors, representing motion between parts of the three successive images.

3. A luminance and color separation filter unit (500) as claimed in claim 1, characterized in that the filter unit (500) comprises a sample acquisition unit (302) to acquire the first (F₁), the second (F₂) and the third (F₃) sample from three portions of the composite color television signal, the three portions corresponding to a single image, the sample acquisition unit (302) being controlled by means for estimating an edge orientation (502) in the single image.

4. A luminance and color separation filter unit (600) as claimed in claim 1, characterized in comprising:
a first low pass filter (602) for filtering a first (U) one of the two color signals;
a second low pass filter (604) for filtering a second (V) one of the two color signals;
a modulator (606) connected to the first low pass filter (602) and the second low pass filter (604), for re-modulating the filtered first (U_{LPF}) one of the two color signals and the filtered second (V_{LPF}) one of the two color signals; and
a subtraction unit (608) for subtracting the output of the modulator (606) from the composite color television signal (CVBS).

5. A luminance and color separation filter unit (700) as claimed in claim 1, characterized in comprising a spatial up-conversion unit (702) for computing the first (F₁), the second (F₂) and the third (F₃) sample on basis of interpolation of samples extracted from the composite color television signal.

6. An image processing apparatus (800) comprising:
receiving means (802) for receiving a composite color television signal, comprising a chrominance signal being modulated on a sub-carrier which is located in the high-frequency part of the frequency spectrum of a luminance signal; and
a luminance and color separation filter unit (300, 400, 500, 600, 700) for extracting the luminance signal and two color signals from the composite color television signal, characterized in that the filter unit (300, 400, 500, 600, 700) is arranged to compute at least one value of a set of values comprising an output luminance value of a particular output pixel, a first color value of the particular output pixel and a second color value of the particular output pixel on basis of a first, a second and a third sample derived from the composite color television signal, where the first, the second and the third sample have mutually different sub-carrier phases.

7. An image processing apparatus (800) as claimed in claim 6, further comprising a display device (804) for displaying images being represented by the luminance signal and the two color signals.

8. An image processing apparatus (800) as claimed in claim 7, characterized in that it is a TV.

9. A method of extracting a luminance signal and two color signals from a composite color television signal, comprising a chrominance signal being modulated on a sub-carrier which is located in the high-frequency part of the frequency spectrum of the luminance signal, characterized in computing at least one value of a set of values comprising an output luminance value of a particular output pixel, a first color value of the particular output pixel and a second color value of the particular output pixel on basis of a first, a second and a third sample derived from the composite color television signal, where the first, the second and the third sample have mutually different sub-carrier phases.

10. A computer program product to be loaded by a computer arrangement, comprising instructions to extract a luminance signal and two color signals from a composite color television signal, comprising a chrominance signal being modulated on a sub-carrier which is located in the high-frequency part of the frequency spectrum of the luminance signal, the computer arrangement comprising processing means and a memory, the computer program product, after being loaded, providing said processing means with the capability to carry out: computing at least one value of a set of values comprising an output luminance value of a particular output pixel, a first color value of the particular output pixel and a second color value of the particular output pixel on basis of a first, a second and a third sample derived from the composite color television signal, where the first, the second and the third sample have mutually different sub-carrier phases.
